(19) United States
(12) Patent Application Publication
(10) Pub. No.: US 2017/0045186 A1
(43) Pub. Date: Feb. 16, 2017

(54) Decorative LED Display

(71) Applicant: UCP International Co. Ltd., Kowloon (HK)

(72) Inventor: Edison Wong, Kowloon (HK)

(21) Appl. No.: 15/237,388

(22) Filed: Aug. 15, 2016

Related U.S. Application Data
(60) Provisional application No. 62/205,610, filed on Aug. 14, 2015.
(60) Provisional application No. 62/324,247, filed on Apr. 18, 2016.

(51) Int. Cl. F21L 4/08; F21V 21/06; F21V 23/00; F21V 3/02; F21V 23/06; F21V 23/04

(52) U.S. Cl. CPC F21L 4/08; F21V 23/06; F21V 23/0414; F21V 23/003; F21V 23/0435; F21V 3/02; F21V 21/06; F21Y 2115/10

(57) ABSTRACT

Decorative LED display devices and/or methods may comprise a base, a head, and a stem. The stem may comprise a first end, and a second end, the first end being connected to the head, and the second end being connected to the base. The first end of the stem may comprise a LED light source while the second end of the stem may comprise a USB connector or a receiver inductor electrically connected to the LED light source. In one embodiment, the base may comprise a base connector for removably coupling with the USB connector. The base may further comprise a power source configured to supply power through USB connector. In another embodiment, the base may comprise a transmitter inductor for inductively coupling with the receiver inductor. The transmitter inductor may be configured to supply power when the receiver inductor and the transmitter inductor are inductively coupled.

### TECHNICAL FIELD

This disclosure generally relates to decorative LED display devices and methods.

### BACKGROUND

Various display devices are used in home, office and other locations for decorative purposes. Various existing decorative display devices may include illuminated devices, such as neon light displays. Various illuminating display devices employ incandescent light bulbs or neon light bulbs for illumination.

### SUMMARY

Decorative LED display devices and/or methods according to various aspects of the present invention may comprise a base, a head, and a stem. The stem may comprise a first end, and a second end, the first end being connected to the head, and the second end being connected to the base. The first end of the stem may comprise a LED light source while the second end of the stem may comprise a USB connector electrically connected to the LED light source. The base may comprise a base connector for removably coupling with the USB connector. The base may further comprise a power source configured to supply power to the LED light source when the USB connector and the base connector are removably coupled.

Decorative LED display devices and/or methods according to various aspects of the present invention may comprise a base, a head, and a stem. The stem may comprise a first end, and a second end, the first end being connected to the head, and the second end being connected to the base. The first end of the stem may comprise a LED light source while the second end may comprise a receiver inductor connected to the LED light source. The base may comprise a transmitter inductor for inductively coupling with the receiver inductor. The transmitter inductor may be configured to supply power to the LED light source when the receiver inductor and the transmitter inductor are inductively coupled.

### BRIEF DESCRIPTION OF THE DRAWINGS

FIG. 1 is a schematic illustration of an embodiment of a decorative LED display device;

FIG. 2 is an exploded view of an embodiment of a first end of a stem of in the decorative LED display device shown in FIG. 1;

FIG. 3 is a schematic illustration of an embodiment of a LED light source of the decorative LED display device shown in FIG. 1;

FIG. 4 is a partial view of an embodiment of a head and the first end of the stem of a decorative LED display device shown in FIG. 1;

FIG. 5A is an exploded view of an embodiment of a second end of the stem of the decorative LED display device shown in FIG. 1;

FIG. 5B is a partial view of the second end of the stem of the decorative LED display device shown in FIG. 1;

FIG. 6 is a partial exploded view of an embodiment of a base of the decorative LED display device shown in FIG. 1;

FIG. 7 is a schematic illustration of an embodiment of a decorative LED display device with a base having an upwardly extended sidewall;

FIG. 8A is a partial elevational view of the base shown in FIG. 7;

FIG. 8B is a partial bottom elevational view of the base shown in FIG. 7;

FIG. 8C is a partial top elevational view of the base shown in FIG. 7;

FIG. 9 is a partial exploded view of the base shown in FIGS. 7 and 8A-C;

FIG. 10 is a schematic illustration of an embodiment of a decorative LED display device with an end of a stem configured for inductive coupling;

FIG. 11A is a partial elevational top view of an embodiment of a base of a decorative LED display device configured for inductive coupling;

FIG. 11B is a partial bottom elevational view of the base shown in FIG. 11A; and

FIG. 11C is a partial exploded view of the base shown in FIG. 11A.

### DETAILED DESCRIPTION

Example embodiments will now be described hereinafter with reference to the accompanying drawings, which form a part hereof, and which illustrate example embodiments which may be practiced. As used in the disclosures and the appended claims, the terms “embodiment”, “example embodiment”, and “exemplary embodiment” do not necessarily refer to a single embodiment, although they may, and various example embodiments may be readily combined and interchanged, without departing from the scope or spirit of example embodiments. Furthermore, the terminology as used herein is for the purpose of describing example embodiments only and is not intended to be limitations. In this respect, as used herein, the term “in” may include “in” and “on”, and the terms “a,” “an” and “the” may include singular and plural references. Furthermore, as used herein, the term “by” may also mean “from”, depending on the context. Furthermore, as used herein, the term “if” may also mean “when” or “upon,” depending on the context. Furthermore, as used herein, the words “and/or” may refer to and encompass any and all possible combinations of one or more of the associated listed items. It will be appreciated by those of ordinary skill in the art that the embodiments disclosed herein can be embodied in other specific forms without departing from the spirit or essential character thereof. The presently disclosed embodiments are therefore considered in all respects to be illustrative and not restrictive.

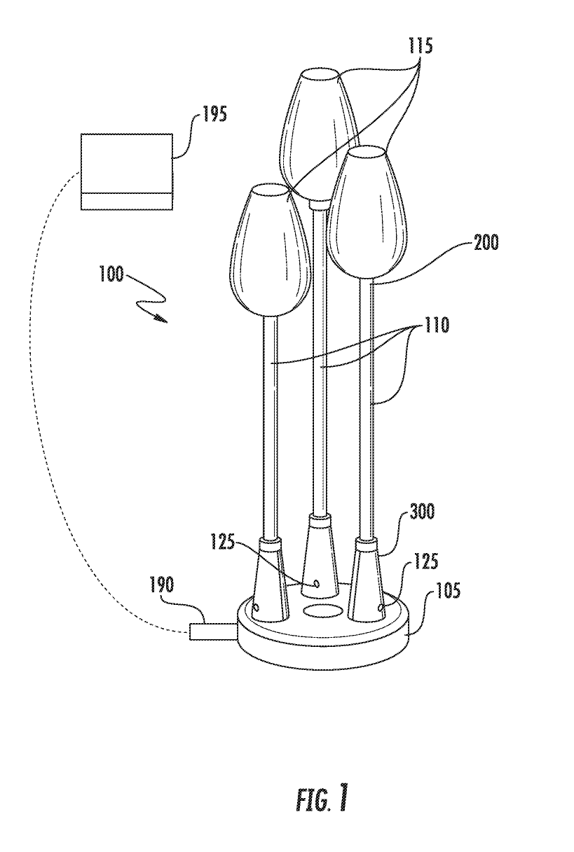

FIGS. 1-5B depict an illustrative embodiment of a decorative LED display device 100. As illustrated, the decorative LED display device 100 may include a base 105, one or more stems 110, and one or more heads 115. In an embodiment, the display 100 may not comprise of a base 105. In an embodiment, the display 100 may comprise of one, two, three or any number of stems 110 and a corresponding number of heads 115. In another embodiment, some or all of the stems 110 may comprise multiple heads 115. In the embodiment illustrated in FIGS. 1-5C, the stem 110 may comprise of a first end 200 and a second end 300. The first end 200 of the stem 110 may connect to the head 115 and the second end 300 may connect to the base 300.

It may be appreciated that in an embodiment, the first end 200 of the stem 110 may removably connect to the one or more heads 115. In another embodiment, the second end 200 of the stem 110 may removably connect to the base 300. Further, in an embodiment, the first end 200 of the stem 110 may permanently connect to the one or more heads 115. In a different embodiment, the second end 200 of the stem 110 may permanently connect to the base 300.

It may be appreciated that in an embodiment, the head 115, and/or stem 110 and/or the base 105 may be of any shape as desired. In an embodiment comprising of multiple heads 115, all of the multiple heads 115 may be of one shape or different shapes. Similarly, in an embodiment comprising of multiple stems 110 and/or multiple bases 105, all of the multiple stems 110 or the multiple bases 105 may be of one shape or different shapes.

It may also be appreciated that in an embodiment, the head 115, and/or stem 110 and/or the base 105 may be made of any material as desired. In an embodiment, the head 115, may be translucent. In an embodiment, the head 115, a partial portion of the stem 110 or an entire portion of the stem 110 may be translucent. Likewise, in an embodiment, the head 115, a partial portion of the base 105 or an entire portion of the base 105 may be translucent. Further, in an embodiment, the entire display device 100 may be translucent.

In an embodiment, the first end 200 of stem 110 includes an LED light source 220 and an LED mount 205 to support the LED light source 220. It may be appreciated that other embodiments may employ multiple LED light sources 220 supported by the LED light frame 205. However, it may be appreciated that a variety of support structures may be used to support the LED light source 220 or the multiple LED sources 220. It may be appreciated that in an embodiment, the head 115 and/or the base 105 and/or the stem 110 may comprise of one or more LED light sources 220 (not shown). It may be appreciated that the one or more LED light sources 220 may display a single color light or varying color lights.

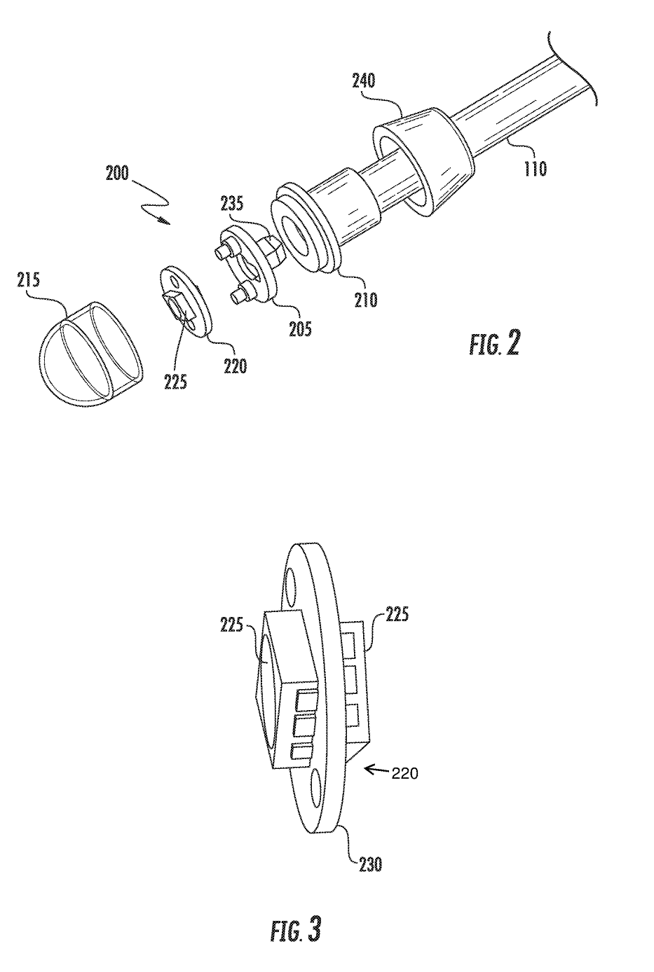

In the embodiment depicted in FIG. 2, the LED mount 205 may be seated onto or in a frame 210. It can be appreciated that a variety of support structures may be used to support the LED mount 205. It may be appreciated that the LED light source 220 may be positioned at different locations in the stem 110.

As also depicted in FIG. 2, a diffuser 215 may be coupled to the frame 210 at least partially over the LED light source 220 to distribute the light from the LED light source 220. In an embodiment, the diffuser 215 has a dome shape. But other shapes may be employed. The diffuser 215 may be formed from different materials including but not limited to polypropylene. The diffuser 215 may also have varying degrees of translucence. It may be appreciated that any light distributing mechanism may be employed in place of a diffuser 215. In an embodiment, the stems 110 may employ different light distributing mechanisms to allow for different visual effects for light emanating from different stems 110.

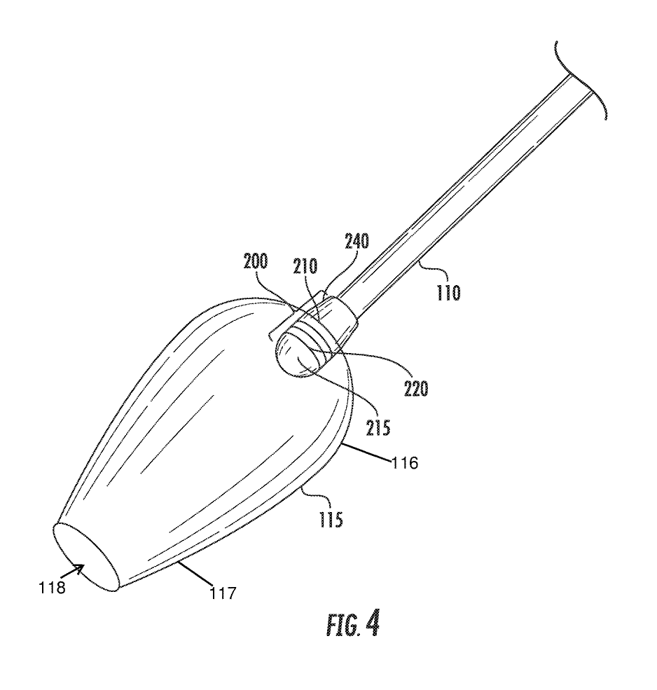

It may be appreciated that in the embodiment depicted in FIG. 2, the LED light source 220 may include one or more surface-mounted-device LEDs 225. As depicted in FIG. 3, in an embodiment, the LED light source 220 may comprise of a plurality of surface-mounted-device LEDs 225 mounted on two sides of a Printed Circuit Board (PCB) 230. Light in such an embodiment may be directed in different directions. It may be appreciated that one or more surface-mounted-device LEDs 225 may be arranged in a variety of ways on a PCB 230 to achieve other visual effects.

It may be appreciated that in one or more embodiments, other types of LED light sources 220 may be employed. And, in other embodiments, the plurality of LED light sources 220 may comprise of different LED light sources 220. It may be appreciated that in one or more embodiments of LED light sources, light may be directed at one or more directions. It also may be readily appreciated that LED light sources 220 may be arranged in a variety of ways.

As depicted in FIG. 2, the LED mount 205 may also include a light passage 235 so light may pass through the LED mount 205 to the stem 110. In some embodiments, the stem 110 may be made from a translucent material, such as a PVC soft tube, so that it will be lit up by light travelling through stem 110 via the light passage 235. When manufactured with a PVC soft tube, the stem 110 may be bendable. A variety of other materials may also be utilized to make the stem 110 and create this effect. And still other materials may be used, if the translucent effect or the bendable effect is not desired. As may be appreciated, the stem 110 may or may not be bendable. Likewise, the stem 110 may or may not be translucent.

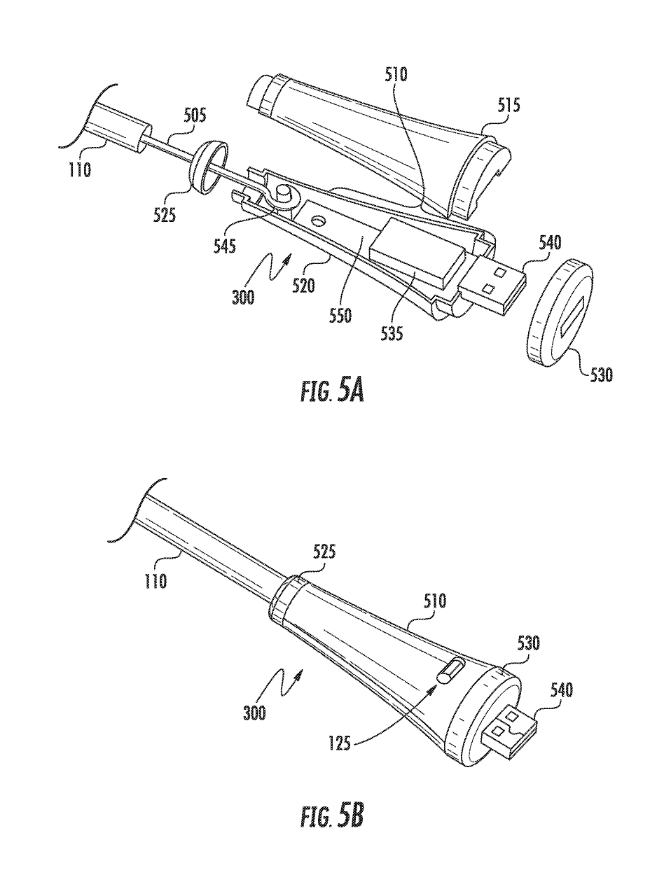

As depicted in FIG. 4, the head 115 may be coupled to the frame 210. Further, as depicted in FIGS. 2 and 4, a cap 240 may be used to secure the head 115 to the stem 110. As may appreciated, a variety of other coupling mechanisms may be used to secure the head 115 to the stem 110. It may be appreciated that the one or more stems 110 may be configured to have various sizes, colors, and shapes.

It may be appreciated that a one or more heads 115 may be manufactured out of a variety of materials including but not limited to plastics. The one or more heads 115 may be configured to have various contours, sizes, colors, and shapes. In an embodiment, the head 115 may preferably comprise of a curved exterior surface, thereby allowing for the appearance of a floral shape. The curved exterior surface may comprise of a curved bottom portion 116 extending to a tapered top portion 117 defining a top opening 118. It may be appreciated that the floral shape may not be limited to a particular shape and may comprise of any shape as desired including but not limited to the shape of a flower. The one or more heads 115 may all have same floral shape. In an embodiment, the one or more heads 115 may each have different floral shapes.

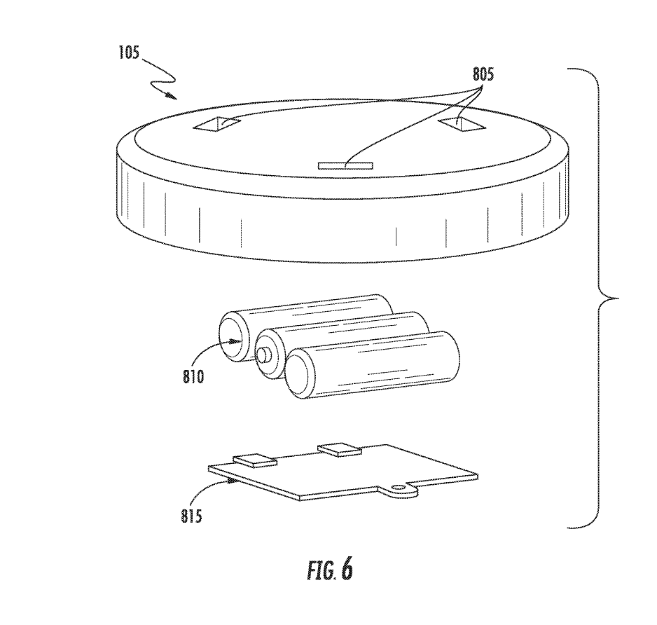

FIGS. 5A and 5B depict an exploded view and an assembled view of an embodiment of a second end 300 of the stem 110, respectively. As depicted in FIGS. 5A-B, the stem 110 may comprise of a supporting rod 505. The supporting rod 505 may extend from the first end 200 to the second end 300 of the stem 110. This rod 505 may comprise copper, iron, or a variety of other materials that is configured to contribute to structural support and/or electrically connect the LED light source 220 to the electrical components located at the second end 300. As depicted in FIG. 5, the rod 505 may be connected to the bottom cover 520 with a hook design 545. As may be appreciated, the rod 505 may be connected to the second end 300 at a variety of locations by a variety of connection mechanisms.

As depicted in FIGS. 5A-5B, the second end 300 may comprise a housing 510. The housing 510 may comprise a top cover 515, a bottom cover 520, a top cap 525, and a bottom cap 530. However, it has to be appreciated that the housing 510 in the embodiment depicted in FIG. 5 may not be limited to such a structure. The housing 510 depicted in FIGS. 5A and 5B may allow for an easy, screw-free assembly and disassembly. In this embodiment the top cap 525 and bottom cap 530 secure the housing 510 in place. But it may be appreciated that in other embodiments the housing 510 may be formed in a variety of different ways.

In one embodiment, the housing 510 may include an optional portable power source, such as a battery 535, electrically connected to the LED light source 220. In an embodiment, the battery 535 may include a rechargeable battery, such as a lithium-ion polymer battery. But it can be appreciated that different types of batteries may be used. Or in other embodiments, there may be no battery at all. For example, in an embodiment, the device 100 may be directly connected to a power source (not shown). In another embodiment, the device 100 may be solar powered. In yet other embodiments of the device 100, a variety of power sources may be employed.

The optional battery 535 depicted in FIG. 5A may be charged by connection via a USB connector 540. This may allow the user to power the battery 535 by connecting it into any USB connector, USB charger, or any power station. This may allow the device 100 to operate in a variety of settings with or without the base 105. While USB connector 540 is shown in FIGS. 5A and 5B to be a male connector, it is to be appreciated that it may be configured as a female connector in other embodiments. Similarly, in other embodiments different types of connectors or mechanisms may be employed to charge the battery 535. As depicted in FIG. 5A, the battery 535 may be electrically connected to a printed circuit board, PCB 550. It, however, is to be appreciated that in an embodiment, the housing 510 may not comprise of a PCB 550.

Further, as depicted in FIGS. 1 and 5B, the second end 300 may comprise of a switch 125. The switch 125 may include multiple settings giving the user different LED light display options. In an embodiment, the switch 125 may have only two settings: on and off. In one embodiment, the LED light source 220 may be designed to produce a steady light when the switch 125 is set to on. In another embodiment, the LED light source 220 may be designed to produce a slow flash light when the switch 125 is set to on. As can readily be appreciated, the LED light source 220 can be designed to display light in a large variety of different ways when the switch 125 is set to on.

It has to be appreciated that in one or more embodiments, the switch 125 may have more than two settings that correspond to different light display options. In one such embodiment, the switch 125 may have three settings which comprise of an on position, a slow flash position, and an off position. Some embodiments may also include one or more auto timers to turn off the decorative LED display device after a predetermined time period, such as 15 minutes, 30 minutes, 60 minutes, etc. In some embodiments the user may adjust the one or more auto timers according to his needs. It is to be appreciated that the switch 125 may be located at any position on the decorative LED display device 100. For example, the switch 125 may be located on the head 115, and/or the first end 200 of the stem 110, and/or the second end 300 of the stem 110, and/or the base 105.

In an embodiment, as depicted in FIG. 1, the decorative LED display device 100 may comprise of a controller 190 in electrical communication with the LED light source 220, either directly or indirectly. In an embodiment, the controller 190 may be triggered by the switch 125 to operate the LED light source 220. In an embodiment, the controller 190 may receive instruction via near field communication (NFC) from a remote device 195 such as a smart phone or tablet or any electronic device capable of such functioning. The controller 190 may direct the operation of the LED light source 220 based on the instruction received from the remote device 195. Some embodiments may also include a near field communication position actuator (not shown) on the switch 125 that allows the user to select between an NFC mode and non-NFC mode. In this manner, the decorative LED display device 100 may be controlled by smart phones, tablets or other devices when the NFC mode is actuated. And, in some embodiments, light patterns among a plurality of decorative LED display devices 100 may be coordinated with a smart phone, tablet, or other devices.

In an embodiment, the illumination of the LED light sources 220 in one or more decorative LED display devices 100 may be turned on or off in unison, in a variety of patterns, and/or sequences. Such operation of the decorative LED display devices 100 may be effected by the controller 190 or by mechanical adjustment of the switch 125. The controller 190 may be preprogrammed to store instructions for illuminating the LED light sources 220 in a particular sequence or timing. In an embodiment, a pre-programmed instruction comprises at least 2 of the on-, off-, or slow-flash modes. In an embodiment instruction for the controller 190 may be provided in real-time from the NFC device 195. It is to be appreciated that the controller 190 may be physically located any position on the decorative LED display device 100. As depicted in FIG. 1, the controller 190 may be located on the base 105. However, the controller 190 may also be located on the head 115, and/or the first end 200 of the stem 110, and/or the second end 300 of the stem 110.

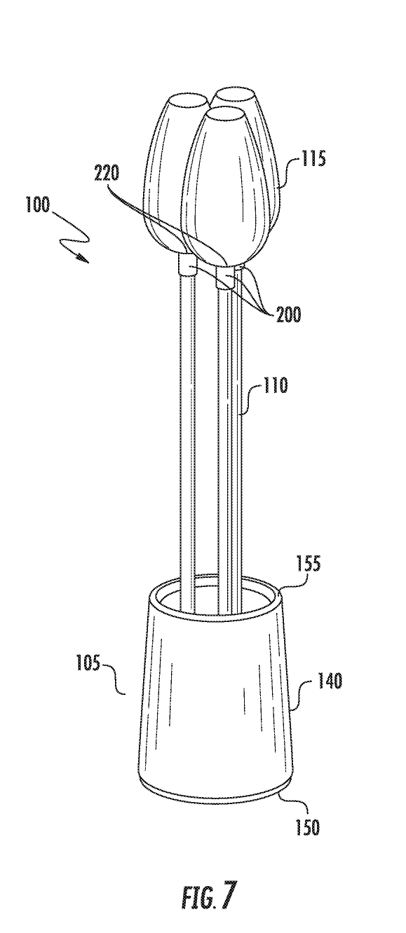

One embodiment of a base 105 of a decorative LED display device 100 is depicted in FIG. 6. In this embodiment, the base includes one or more base connectors 805 to receive the USB connector 540 from the second end 300 of the stem 110. In this embodiment, the base has three base connectors 805 to receive the USB connector 540 from each of the three stems 110. As can be appreciated, the base 105 may include other number of base connectors 805 as desired. Also, the base 105 may comprise of other types of connectors (not shown) to correspond to the type of connector or connectors used in the decorative LED display device 100.

The base 105 may have an optional power source 810. As depicted in FIG. 6, this power source 810 can take the form of AA batteries or other types of batteries. However, in other embodiments, a variety of power sources may be employed such as solar power, or direct connection to an electrical outlet configured to provide AC or DC current. A battery door 815, may also be used to secure the batteries in place. It is to be appreciated that the optional power source 810 may supply power to light up the LED display device 100 when the USB connector 540 and the base connector 805 are removably coupled to each other.

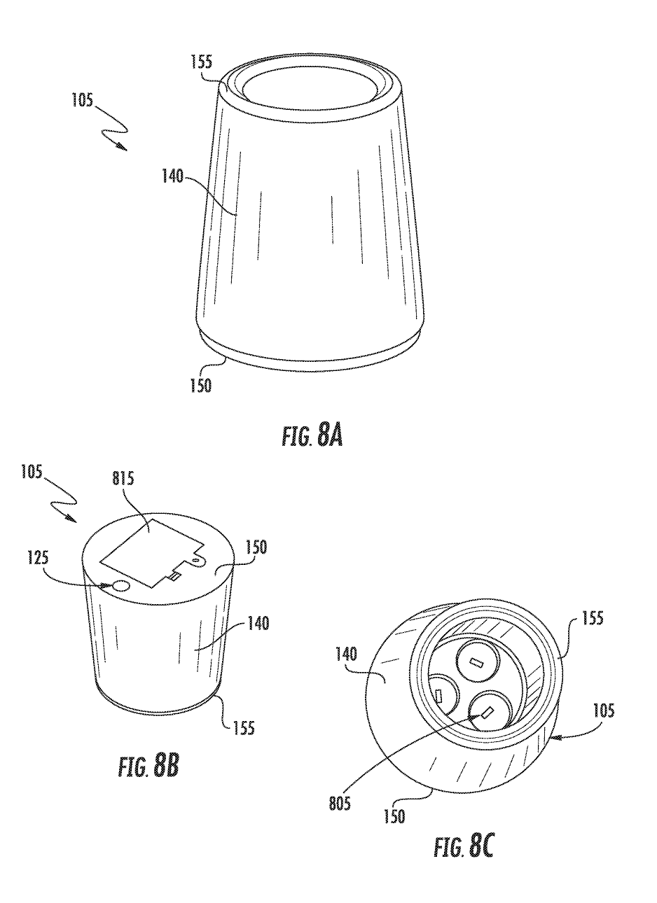

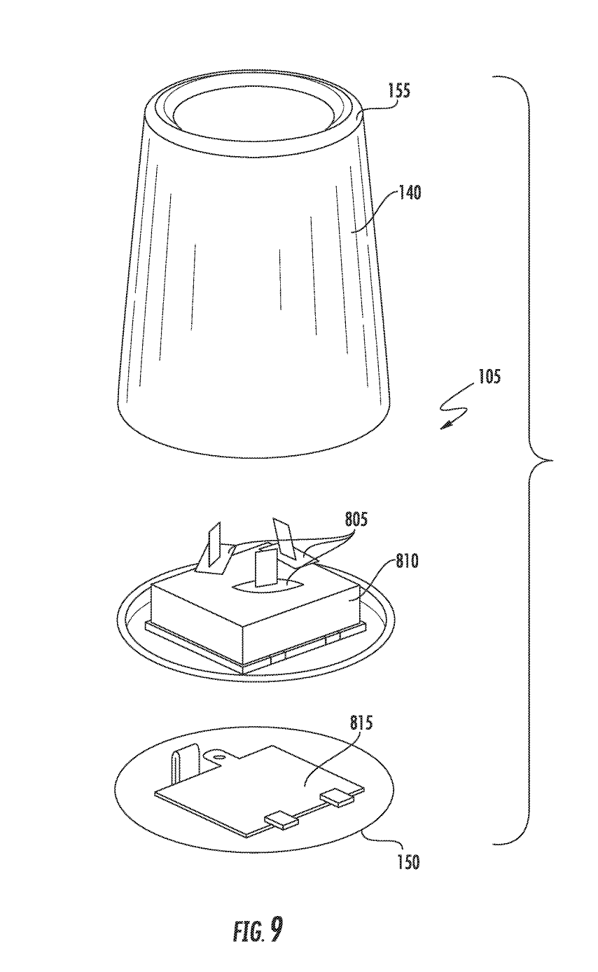

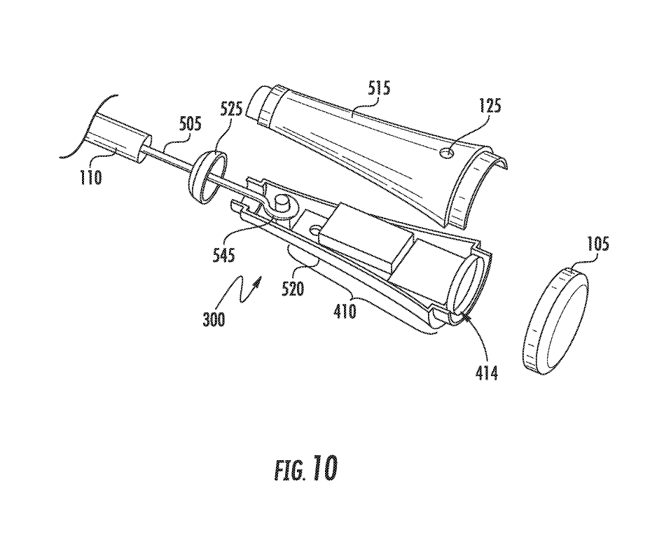

It may be appreciated that the base 105 may be configured to have various sizes, colors, and shapes. FIGS. 7-9 depict an embodiment of a decorative LED display device 100, wherein the base 105 may be a vase-like base 105. The vase-like base 105 may comprise of a side wall 140 surrounding the second end 300 of a plurality of stems 110. The side wall 140 may have a height that extends from a base surface 150 of the base 105 to an upper end 155 of the base 105. The side wall 140 may be configured to define an upper opening for the stems 110 to extend there through. The height of the side wall 1140 may be configured to be at least greater than the height of the second end of the plurality of stems 110 thereby partially obstructing the elevational view of the electrical connections between the second end 300 of the stems 110 and the base 105.

In an embodiment, the height of the side wall 1140 may be configured to be greater than the height of the second end of the plurality of stems 110 thereby completely obstructing the elevational view of the electrical connections between the second end 300 of the stems 110 and the base 105. The vase-like base 105 may take the shape of a tumbler as depicted in FIGS. 7-9. In other embodiments, the vase-like base 105 may be of any shape as desired by the user. The vase-like base 105 may comprise of a power source 810. The power source 810 may be chosen from a variety of power sources such as AA batteries, solar power etc. A door 815 may be provided on the base surface 150 to secure the power source 810 in place.

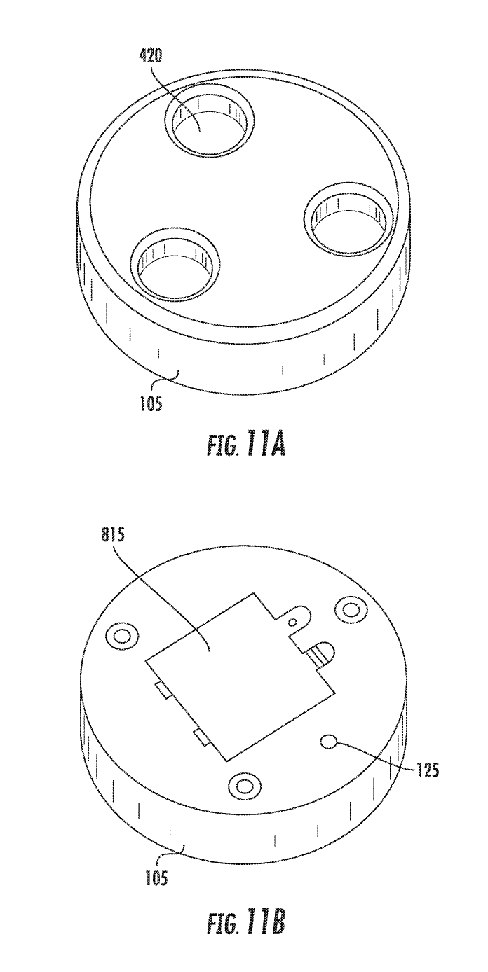

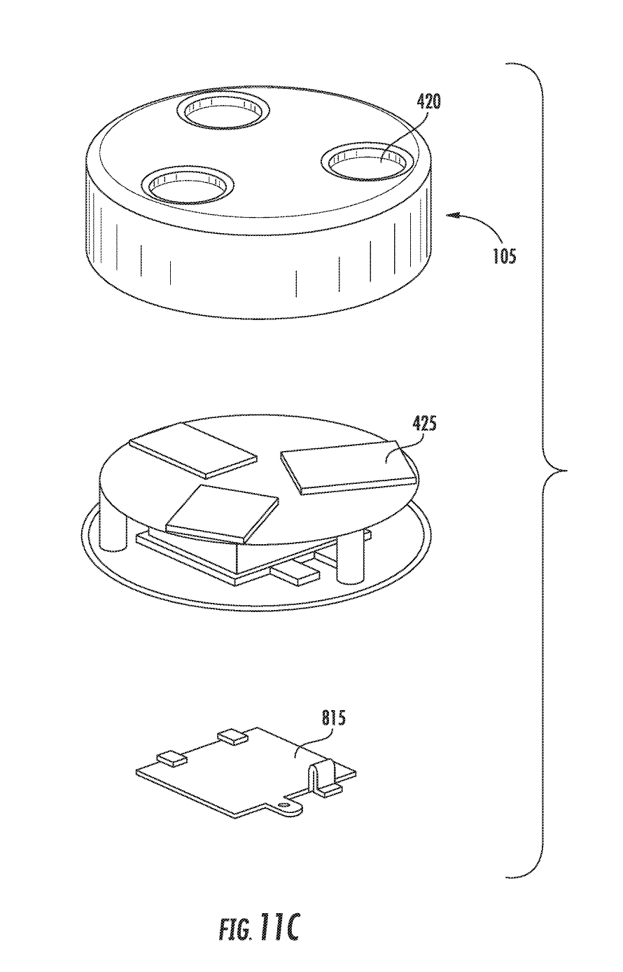

FIGS. 10-11C depict an embodiment of a decorative LED display device 100 wherein the device 100 is configured for induction powering. As depicted in FIG. 10, the second end 300 of the stem 110 may comprise of a receiver inductor housing 410, which may comprise a receiver inductor 414 instead of a battery 535 and a USB connector 540. The receiver inductor 414 is configured to inductively couple with the transmitter inductor 425 in the base 105. In an embodiment, the second end 300 may be disposed in or proximate to a recessed portion 420 having a sufficient depth in the base 105 so as to allow effective inductive coupling of the transmitter inductor 425 and the receiver inductor 414. In an embodiment, the depth of the recessed portion 420 may be configured to provide a snuggle fit with the second end 300 so that it also provides structural support for the stem 110

In an embodiment, the transmitter inductor 425 may be driven to generate a magnetic field that would induce a voltage in the receiver inductor 414 to power the LED light source 220 directly. In another embodiment, the transmitter inductor 425 may be driven to generate a magnetic field that would induce a voltage in the receiver inductor 414 to power a battery 535 connected to the stem 110, which will then supply power to the LED light source 220. It is to be appreciated that when the transmitter inductor 425 and the receiver inductor 414 are inductively and removably coupled to each other, power is provided to the LED light source 220 to light up the LED display device 100.

The base 105 may be a flat base as depicted in FIGS. 10-11C or a vase-like base as illustrated in FIGS. 7-9. The base 105 may also comprise of a switch with one or more settings. The one or more settings may be on position, off position and/or other positions that offer desired controls of the decorative LED display device such as slow flash mode of operation etc. It may be appreciated that in an arrangement of decorative LED display devices, one or more of the display devices 100 may be powered by a variety of power sources including but not limited to batteries, solar power source, direct electric source, and/or induction power source.

While various embodiments in accordance with the disclosed principles have been described above, it should be understood that they have been presented by way of example only, and are not limiting. Thus, the breadth and scope of the example embodiments described herein should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result. Words relating to relative position of elements such as “about,” “near,” “proximate to,” and “adjacent to” shall mean sufficiently close to have a material effect upon the respective system element interactions.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A display structure comprising:
a base;
a head; and
a stem;
wherein the stem comprises a first end, and a second end, the first end being connected to the head, and the second end configured for removable connection with the base;
wherein the first end comprises a LED light source; and
wherein the second end comprises a USB connector electrically connected to the LED light source; and
wherein the base comprises:
a base connector for removable connection with the USB connector; and
a power source configured to supply power through the USB connector when the USB connector and the base connector are removably connected.

2. The display structure of claim 1, wherein the second end of the stem comprises a battery, and wherein the battery is electrically connected to the USB connector and is configured to be charged by the power source in the base and supply power to the LED light source.

3. The display structure of claim 1, wherein the display structure comprises a controller in electrical communication with the LED light source, and wherein the controller is configured to receive instruction for operating the LED light source.

4. The display structure of claim 3, wherein the display structure further comprises a switch is configured to trigger the controller to operating the LED light source according to a pre-programmed instruction.

5. The display structure of claim 4, wherein the pre-programmed instruction comprises at least 2 of the on-, off-, or slow-flash modes.

6. The display structure of claim 4, wherein the switch is configured a near the controller to operate in a near field communication mode.

7. The display structure of claim 1, wherein the head comprises a curved exterior surface comprising a curved bottom portion extending to a tapered top portion, which defines a top opening.

8. The display structure of claim 7, wherein the head is disposed around the LED light source.

9. The display structure of claim 1, wherein the display structure further comprises a plurality of stems and the base further comprises a corresponding number of plurality of base connectors.

10. The display structure of claim 1, wherein the USB connector is a female connector.

11. The display structure of claim 1, wherein the base comprises a sidewall surrounding the second end of the stems.

12. The display structure of claim 11, wherein the sidewall has a height that extends from a base surface of the base to an upper end of the base, the height being greater than a height of the second end of the stem.

13. A display structure comprising:
a base;
a head; and
a stem;
wherein the stem comprises a first end, and a second end, the first end being connected to the head, and the second end configured for removable connection with the base;
wherein the first end comprises a LED light source; and
wherein the second end comprises a receiver inductor electrically connected to the LED light source; and
wherein the base comprises a transmitter inductor for inductively coupling with the receiver inductor; and configured to supply power to the LED light source when the receiver inductor and the transmitter inductor are inductively coupled.

14. The display structure of claim 13, wherein the second end of the stem comprises a battery, and wherein the battery is electrically connected to the USB connector and is configured to be charged by the power source in the base and supply power to the LED light source.

15. The display structure of claim 13, wherein the display structure comprises a controller in electrical communication with the LED light source, and wherein the controller is configured to receive instruction for operating the LED light source.

16. The display structure of claim 15, wherein the display structure further comprises a switch is configured to trigger the controller to operating the LED light source according to a pre-programmed instruction.

17. The display structure of claim 16, wherein the pre-programmed instruction comprises at least 2 of the on-, off-, or slow-flash modes.

18. The display structure of claim 16, wherein the switch is configured a near the controller to operate in a near field communication mode.

19. The display structure of claim 13, wherein the head comprises a curved exterior surface comprising a curved bottom portion extending to a tapered top portion, which defines a top opening, wherein the head is disposed around the LED light source.

20. The display structure of claim 13, wherein the display structure further comprises a plurality of stems and the base further comprises a corresponding number of plurality of base connectors.

21. The display structure of claim 13, wherein the base comprises a sidewall surrounding the second end of the stems, wherein the sidewall has a height that extends from a base surface of the base to an upper end of the base, the height being greater than a height of the second end of the stem.
